(19) United States
(12) Patent Application Publication
(10) Pub. No.: US 2010/0320338 A1
(43) Pub. Date: Dec. 23, 2010

(54) HOLDER FOR A GARDEN HOSE DISPLAY

(75) Inventor: Chin-Yuan Chen, CHANG-HUA HSIEN (TW)

Correspondence Address: Yen Jung Sung, 21-80 38 St, #C8, Astoria, NY, 11105, US

(73) Assignee: SHIN TAI SPURT WATER OF THE GARDEN TOOLS CO., LTD., CHANG-HUA HSIEN (TW)

(21) Appl. No.: 12/487,642

(22) Filed: Jun. 18, 2009

(51) Int. Cl. F16M 11/22

(52) U.S. Cl. 248/121

(57) ABSTRACT

A holder for displaying a garden hose includes a base, a holding board, and a plurality of supporting rods disposed between the base and the holding board. The base has positioning holes at four corners and a center of the base, and a plurality of protrusions disposed in a predetermined arrangement on an upper surface of the base. Two long side edges of the base have an inclined or beveled surface, and the holding board has a plurality of fastening slots with different depths on both of two opposing sides. The fastening slot has a V-shaped opening with a narrowing end and a curved surface at the end. The curved surface has three evenly placed flanges, and each flange narrows or tapers from an upper side to a lower side of the holding board. A lower end of two lateral sides of the curved surface has a stopping edge. The narrowing opening of the fastening slot assists a positioning movement, and the arrangement of the three flanges and two stopping edges stabilizes the positioning of the garden hose.

### BACKGROUND OF THE INVENTION

1. Field of the Invention

The present invention relates to a display holder, and more particularly, to a holder for a garden hose display, in which a fastening slot of a holding board has a narrowing end which helps with the positioning of the garden hose, and three flanges on the upper region and two stopping edges on the lower region of the fastening slot form an alternate positioning effect to stabilize the garden hose.

2. Description of the Related Art

Currently, a prior art garden hose holder, as shown in FIG. 8 and FIG 9, is composed of a base 50 and a slotted holder 60, the slotted holder 60 is supported by four rods 70 at the four corners of the base 50. The base 50 is stepped with a higher surface 51 and two lower surfaces 52, and a plurality of positioning holes 53 are arranged in an alternating pattern on the higher surfaces 51 and the lower surfaces 52. Furthermore, one side of each positioning hole 53 has a groove 54 for accepting a control switch on a handle 81 of a garden hose 80. The slotted holder 60 has slots 61 on both of its length-wise sides; the slots have two sets of positioning flanges 62, 63 on their sidewalls; the first set of positioning flanges 62 correspond to the positioning holes 53 of the higher surface 51 of the base 50; the second set of positioning flanges 63 correspond to the positioning holes 53 of the lower surface 52 of the base 50. When the garden hose 80 is placed in the positioning hole 53 of the higher surface 51, the tube body of the garden hose 80 engages with the first set of flanges 62; and when the garden hose 80 is placed in the positioning hole 53 of the lower surface 51, the tube body of the garden hose 80 engages with the second set of flanges 63.

The prior art structure has some drawbacks:

1. The slot of the slotted holder is a straight lined slot and has the two sets of positioning flanges; when the garden hose is to be positioned it is difficult to correctly align the garden hose with the slot and the four-edged positioning of the garden hose 80 is not sufficiently stable.

2. As noted above, the positioning holes of the base are alternately arranged, and a side of each positioning hole has the groove for accepting the control switch on the handle of the garden hose 80. However, the positioning hole limits the outer diameter of the handle 81 of the garden hose and so is not suitable for every type of garden hose; additionally, the control switch of the garden hose is inserted into the groove and so the garden hose cannot be rotated to different directions for display purposes.

3. The four rods standing between the base and the slotted holder only provides four-point support, which is not sufficiently stable.

Therefore, it is desirable to provide a holder for a garden hose display to mitigate and/or obviate the aforementioned problems.

### SUMMARY OF THE INVENTION

A main objective of the present invention is to provide a holder for a garden hose display, which provides an alternate positioning effect to stabilize the garden hose.

In order to achieve the objective, the holder for displaying a garden hose of the present invention comprises a base, a holding board, and a plurality of supporting rods disposed between the base and the holding board. The base has positioning holes at four corners and a center of the base, and a plurality of protrusions disposed in a predetermined arrangement on an upper surface of the base. Two long side edges of the base have an inclined or beveled surface, and the holding board has a plurality of fastening slots with different depths on both of two opposing sides. The fastening slot has a V-shaped opening with a narrowing end and a curved surface at the narrowing end. The curved surface has three evenly placed flanges, and each flange narrows or tapers from an upper side to a lower side of the holding board. A lower end of two lateral sides of the curved surface has a stopping edge. The bottom surface of the holding board has engaging holes corresponding to the positioning holes of the base. The plurality of supporting rods are inserted in the positioning holes and the engaging holes, and each curved surface of the holding board is positioned directly above each protrusion of the base.

The present invention can be used for displaying different types of garden hose. The garden hose is composed of a hose head, a tube body and a handle. In order to arrange the garden hose, the garden hose is slid into the fastening slot on the side of the base, the bottom end of the handle is jacketed onto the protrusions of the base, and the hose head is pressed against the inner side of the fastening slot so that the tube body is pushed against the flanges of the curved surface and set into place by the stopping edges on the curved surface of the fastening slot. When the garden hose is held between the base and the holding board, the flange of the curved surface pushes against the upper region of the tube body, and the stopping edge pushes against the lower region of the tube body so that alternating positioning engagement is provided to the garden hose. The inclining surfaces on the two sides of the base assist in accessing the garden hose.

With the above-mentioned structure, the present invention has the following benefits:

1. While placing the garden hose, the fastening slot has the narrowing end which helps the positioning movement of the garden hose, and the three flanges on the upper region and two stopping edges on the lower region of the fastening slot form an alternating positioning effect to stabilize the garden hose.

2. the top surface of the base has the plurality of protrusions, the handle of the garden hose is jacketed onto the protrusions; handles having different sizes of outer diameters or hole diameters of the handle can all engage with the protrusions, and the garden hose can still be rotated into different directions for display purposes.

3. The base has the positioning holes at its four corners as well as in a center position; the holding board also has the engaging holes at its four corners and a corresponding center position. The supporting rods placed between the positioning holes and the engaging holes provide five supporting points for a more sturdy structure.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the present invention.

FIG. 2 is a perspective exploded view of the present invention.

FIG. 3 is a first detailed view of a fastening slot according to the present invention.

FIG. 4 is a second detailed view of a fastening slot according to the present invention.

FIG. 5 shows a garden hose being displayed according to the present invention.

FIG. 6 is a first detailed view of a fastening slot holding the garden hose according to the present invention.

FIG. 7 is a second detailed view of the fastening slot holding the garden hose according to the present invention.

FIG. 8 is a schematic drawing of prior art.

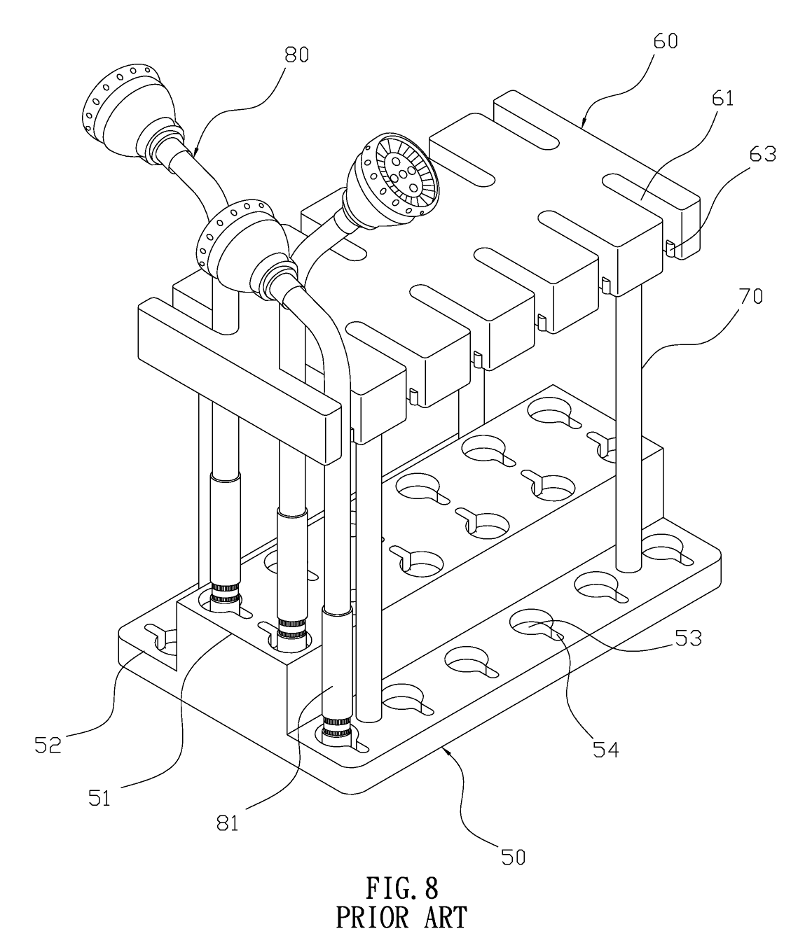

FIG. 9 is a detailed view of a prior art device holding a garden hose.

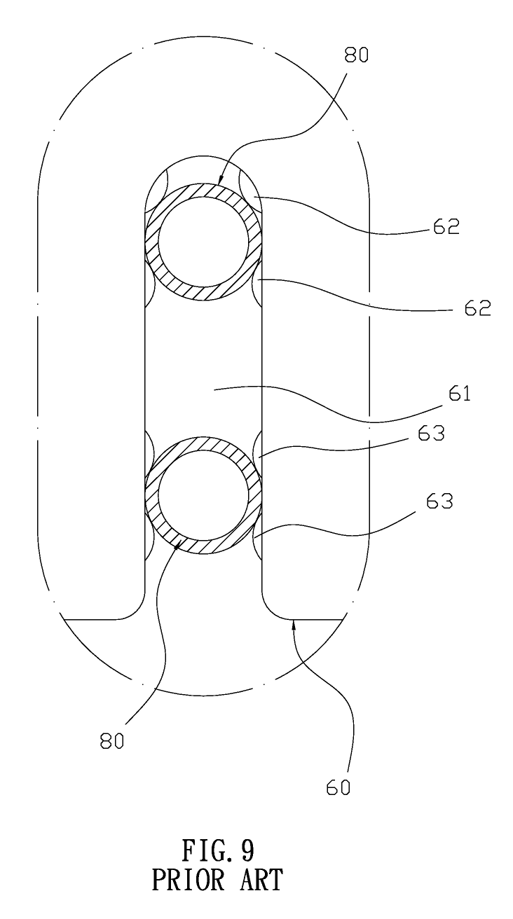

### DETAILED DESCRIPTION OF THE PREFERRED EMBODIMENT

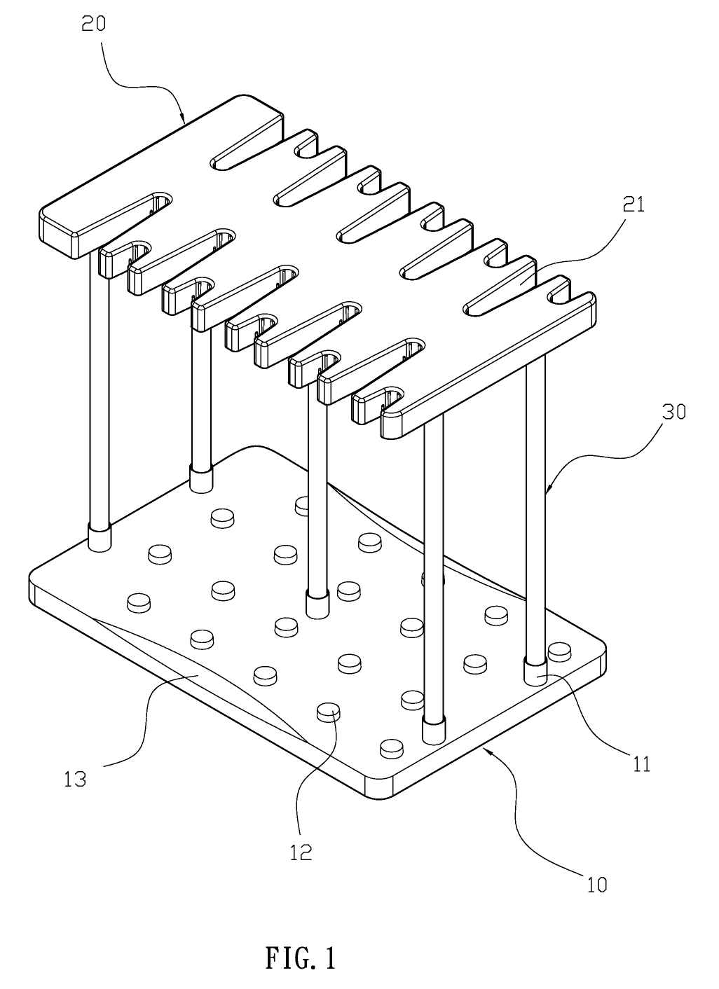

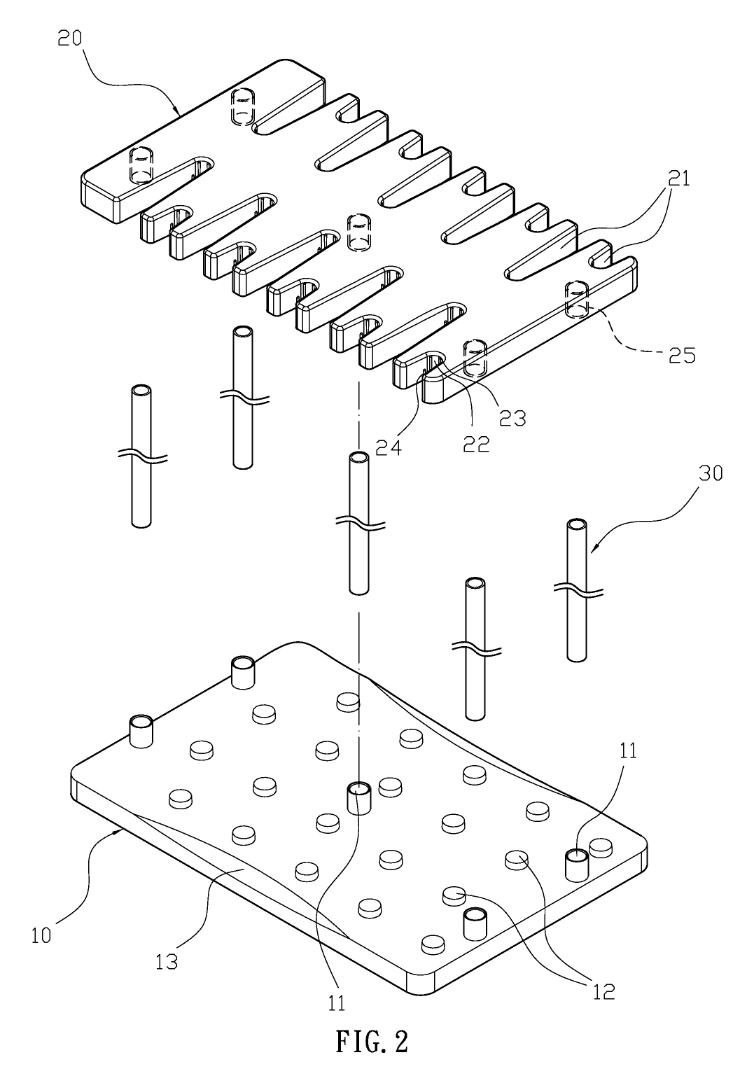

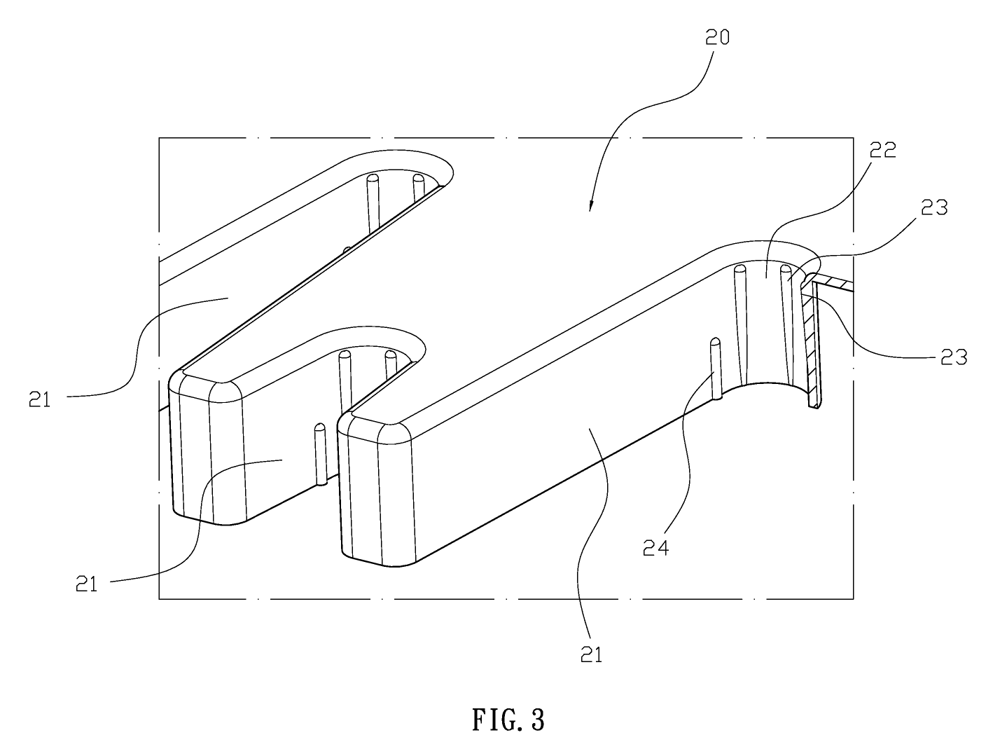

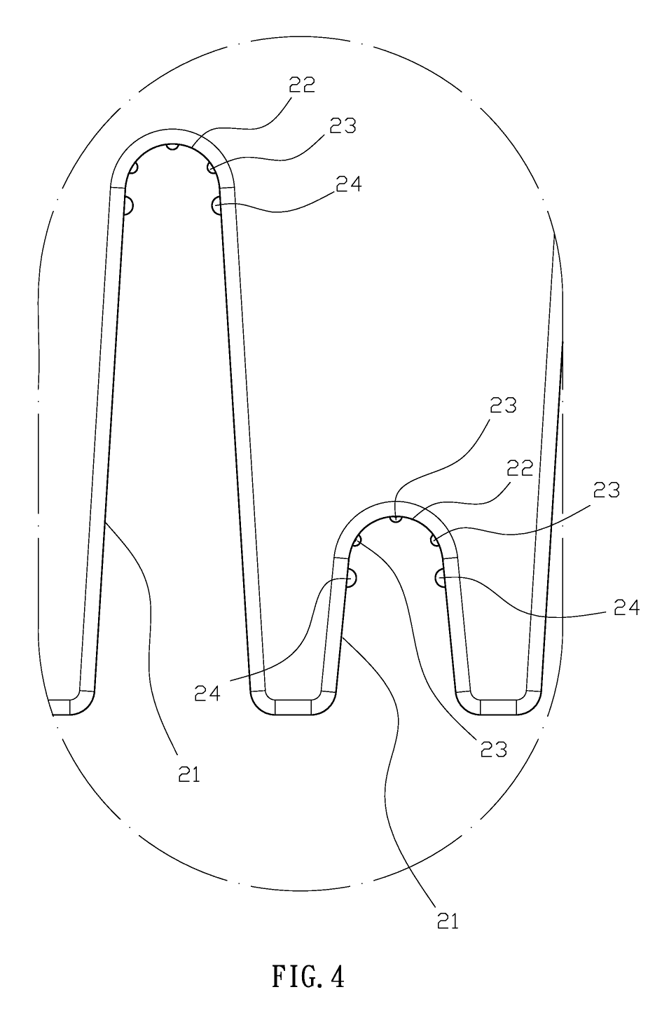

Please refer to FIG. 1 to FIG. 4. A holder for displaying a garden hose comprises a base 10, a holding board 20, and a plurality of supporting rods 30 disposed between the base 10 and the holding board 20. The base 10 has positioning holes 11 at four corners and a center of the base, and a plurality of protrusions 12 disposed in a predetermined arrangement on an upper surface of the base 10. Two long side edges of the base 10 have an inclined or beveled surface 13, and the holding board 20 has a plurality of fastening slots 21 with different depths on both of two opposing sides. The fastening slot 21 has a V-shaped opening with a narrowing end and a curved surface 22 at the narrowing end. The curved surface 22 has three evenly placed flanges 23, and each flange 23 narrows or tapers from an upper side to a lower side of the holding board 20. A lower end of two lateral sides of the curved surface 22 has a stopping edge 24. The bottom surface of the holding board 20 has engaging holes 25 corresponding to the positioning holes 11 of the base 10. The plurality of supporting rods 30 are inserted in the positioning holes 11 and the engaging holes 25, and each curved surface 22 of the holding board 20 is positioned directly above each protrusion 12 of the base 10.

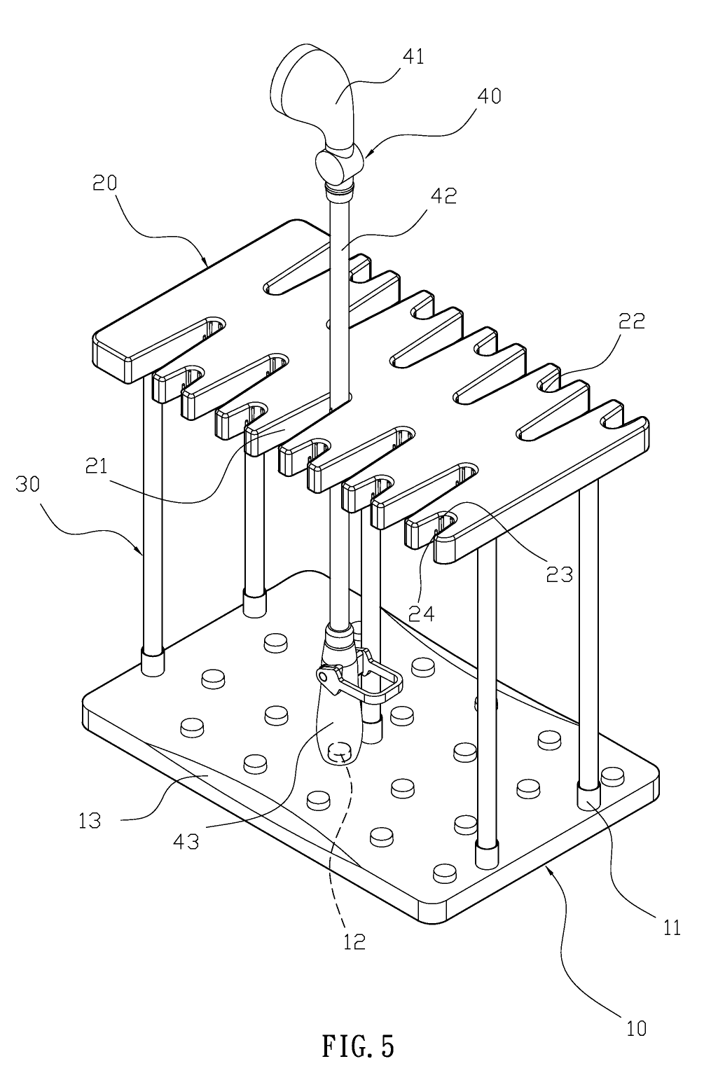

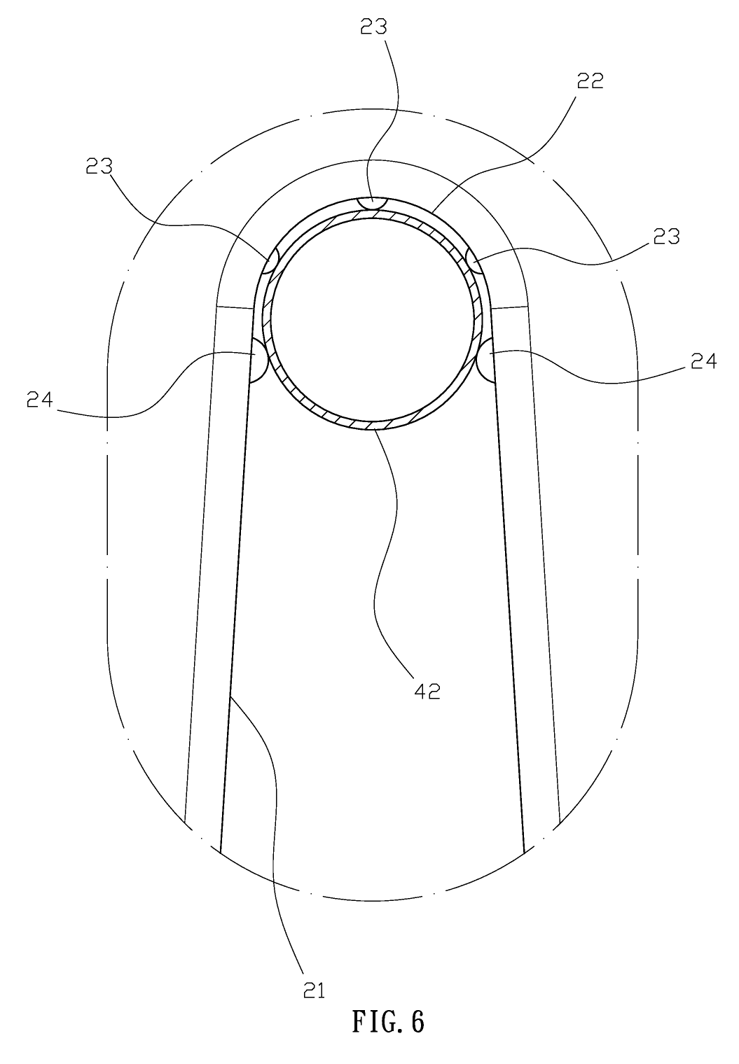

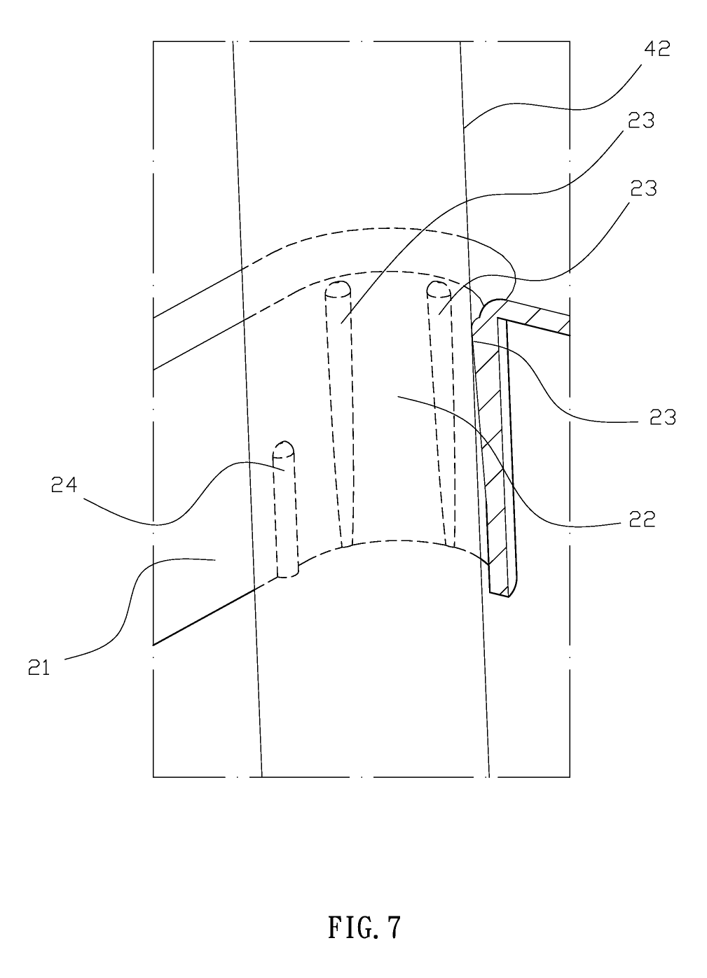

Please refer to FIG. 5 and FIG. 6. The present invention can be used for displaying different types of garden hose 40. The garden hose 40 is composed of a hose head 41, a tube body 42 and a handle 43. In order to arrange the garden hose 40, the garden hose 40 is slid into the fastening slot 21 on the side of the base 10, the bottom end of the handle 43 is jacketed onto the protrusions 12 of the base 10, and the hose head 41 is pressed against the inner side of the fastening slot 21 so that the tube body 42 is pushed against the flanges 23 of the curved surface 22 and set into place by the stopping edges 24 on the curved surface 22 of the fastening slot 21. With reference to FIG. 7, when the garden hose 40 is held between the base 10 and the holding board 20, the flange 23 of the curved surface 22 pushes against the upper region of the tube body 42, and the stopping edge 24 pushes against the lower region of the tube body 42 so that alternating positioning engagement is provided to the garden hose 40. The inclining surfaces 13 on the two sides of the base 10 assist in accessing the garden hose 40.

With the above-mentioned structure, the present invention has the following benefits: First, while placing the garden hose 40, the fastening slot 21 has the narrowing end which helps the positioning movement of the garden hose 40, and the three flanges 23 on the upper region and two stopping edges 24 on the lower region of the fastening slot 21 form an alternating positioning effect to stabilize the garden hose 40. Second, the top surface of the base 10 has the plurality of protrusions 12, the handle 43 of the garden hose 40 is jacketed onto the protrusions 12; handles 43 having different sizes of outer diameters or hole diameters of the handle 43 can all engage with the protrusions 12, and the garden hose 40 can still be rotated into different directions for display purposes. And third, the base 10 has the positioning holes 11 at its four corners as well as in a center position; the holding board 20 also has the engaging holes 25 at its four corners and a corresponding center position. The supporting rods 30 placed between the positioning holes 11 and the engaging holes 25 provide five supporting points for a more sturdy structure.

Although the present invention has been explained in relation to its preferred embodiment, it is to be understood that many other possible modifications and variations can be made without departing from the spirit and scope of the invention as hereinafter claimed.

What is claimed is:

1. A holder for a garden hose display comprising a base and a holding board, and a plurality of supporting rods placed between the base and the holding board;
the base having positioning holes at four corners and a center of the base, and a plurality of protrusions disposed in a predetermined arrangement on an upper surface of the base;
the holding board having a plurality of fastening slots with different depths on both of two sides; the fastening slots having a U-shaped opening with a narrowing end and a curved surface at the narrowing end, the curved surface having at least one flange, the flange narrowing from an upper side to a lower side of the holding board; a lower end of two parallel sides having a stopping edge; and the bottom surface of the holding board having engaging holes corresponding to the positioning holes of the base;
wherein when placing a garden hose, the narrowing opening of the fastening slot assists a positioning movement, and the arrangement of the three flanges and two stopping edges stabilizes the positioning of the garden hose.

2. The holder for a garden hose display as claimed in claim 1, wherein two long side edges of the base have an inclining surface.

3. The holder for a garden hose display as claimed in claim 1, wherein each curved surface of the holding board is placed right above each protrusion of the base.
